(19) United States
(12) Patent Application Publication
(10) Pub. No.: US 2007/0258492 A1
(43) Pub. Date: Nov. 8, 2007

(54) Light-emitting resonant structure driving raman laser

(75) Inventor: Jonathan Gorrell, Gainesville, FL (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Virgin Islands Microsystems, Inc., St. Thomas, VI (US)

(21) Appl. No.: 11/418,091

(22) Filed: May 5, 2006

(51) Int. Cl. H01S 3/00; H01S 3/30

(52) U.S. Cl. 372/3; 372/2

(57) ABSTRACT

In a laser system, a set of substantially coherent electromagnetic radiation is applied as an input to a Raman laser. The Raman laser may be fabricated on the same integrated circuit as the source of the substantially coherent electromagnetic radiation or may be fabricated on a different integrated circuit as the source of the substantially coherent electromagnetic radiation.

### CROSS-REFERENCE TO CO-PENDING APPLICATIONS

The present invention is related to the following co-pending U.S. patent applications: (1) U.S. patent application Ser. No. 11/238,991, [atty. docket 2549-0003], entitled “Ultra-Small Resonating Charged Particle Beam Modulator,” and filed Sep. 30, 2005; (2) U.S. patent application Ser. No. 10/917,511, filed on Aug. 13, 2004, entitled “Patterning Thin Metal Film by Dry Reactive Ion Etching,”; (3) U.S. application Ser. No. 11/203,407, filed on Aug. 15, 2005, entitled “Method Of Patterning Ultra-Small Structures”; (4) U.S. application Ser. No. 11/243,476 [Atty. Docket 2549-0058], entitled “Structures And Methods For Coupling Energy From An Electromagnetic Wave,” filed on Oct. 5, 2005; (5) U.S. application Ser. No. 11/243,477 [Atty. Docket 2549-0059], entitled “Electron Beam Induced Resonance,” filed on Oct. 5, 2005, (6) U.S. application Ser. No. 11/411,130 [Atty. Docket 2549-0004], entitled “Charged Particle Acceleration Apparatus and Method,” filed on Apr. 26, 2006, and (6) U.S. application Ser. No. 11/411,129 [Atty. Docket 2549-0005], entitled “Micro Free Electron Laser (FEL),” filed on Apr. 26, 2006, all of which are commonly owned with the present application at the time of filing, and the entire contents of each of which are incorporated herein by reference.

### BACKGROUND OF THE INVENTION

1. Field of the Invention

The present invention is directed to structures and methods of applying electromagnetic radiation as an input to an optical device, and in one embodiment to structures and methods of applying to a Raman laser source coherent light using electrons in an electron beam and a set of resonant structures which resonate at a frequency higher than a microwave frequency.

2. Discussion of the Background

It is possible to emit a beam of charged particles according to a number of known techniques. Electron beams are currently being used in semiconductor lithography operations, such as in U.S. Pat. No. 6,936,981. The abstract of that patent also discloses the use of a “beam retarding system [that] generates a retarding electric potential about the electron beams to decrease the kinetic energy of the electron beams substantially near a substrate.”

An alternate charged particle source includes an ion beam. One such ion beam is a focused ion beam (FIB) as disclosed in U.S. Pat. No. 6,900,447 which discloses a method and system for milling. That patent discloses that “The positively biased final lens focuses both the high energy ion beam and the relatively low energy electron beam by functioning as an acceleration lens for the electrons and as a deceleration lens for the ions.” Col. 7, lines 23-27.

Free electron lasers are known. In at least one prior art free electron laser (FEL), very high velocity electrons and magnets are used to make the magnetic field oscillations appear to be very close together during radiation emission. However, the need for high velocity electrons is disadvantageous. U.S. Pat. No. 6,636,534 discloses a FEL and some of the background thereon.

Raman lasers are also known, such as in U.S. Pat. No. 6,901,084. Furthermore, considerable research efforts have been made to find ways to integrate Raman laser capabilities with traditional semiconductor processes using silicon. One such effort was detailed in Demonstration of a silicon Raman laser, by Boyraz and Jalai, as published in Vol. 12, No. 21, Optics Express, October 2004.

### SUMMARY OF THE INVENTION

It is an object of the present invention to utilize substantially-coherent light as an input to a Raman laser (e.g., a silicon Raman laser) using charged particles in a beam and a set of resonant structures which resonate at a frequency higher than a microwave frequency to produce the substantially-coherent light.

According to one aspect of the present invention, a beam of charged particles (e.g., electrons) are pre-bunched and then directed into a series of alternating electric fields such that the electrons undergo accelerations and decelerations to cause the electrons to produce emitted light which can then be used as an input to a Raman laser.

According to another aspect of the present invention, a beam of charged particles is used to cause periodically spaced resonant structures to resonate at a frequency higher than a microwave frequency to produce the substantially-coherent light which can then be used as an input to a Raman laser.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a top-view, high-level conceptual representation of a charged particle moving through a series of alternating electric fields according to a first embodiment of the present invention;

FIG. 2 is a top-view, high-level conceptual representation of a charged particle accelerating while being influenced by at least one field of a series of alternating electric fields according to a second embodiment of the present invention;

FIG. 3 is a top-view, high-level conceptual representation of a charged particle decelerating while being influenced by at least one field of a series of alternating electric fields according to a second embodiment of the present invention;

FIG. 4 is a perspective-view, high-level conceptual representation of a charged particle moving through a series of alternating electric fields produced by a resonant structure;

FIGS. 5A-5C are the outputs of a computer simulation showing trajectories and accelerations of model devices using potentials of +/−100V, +/−200V and +/−300V, respectively;

FIG. 6 is a top-view, high-level conceptual representation of a charged particle moving through a series of alternating electric fields according to a first embodiment of the present invention such that photons are emitted in phase with each other;

FIG. 7 is a top-view, high-level conceptual representation of a charged particle moving through a series of alternating electric fields according to a second embodiment of the present invention that includes a focusing element;

FIG. 8 is a top-view, high-level conceptual representation of a charged particle moving through a series of alternating electric fields according to a third embodiment of the present invention that includes a pre-bunching element;

FIGS. 9A through 9H are exemplary resonant structures acting as pre-bunching elements; and

FIG. 10 is a top-level diagram of a Raman laser for producing coherent laser-light from a substantially coherent light source according to the present invention.

### DISCUSSION OF THE PREFERRED EMBODIMENTS

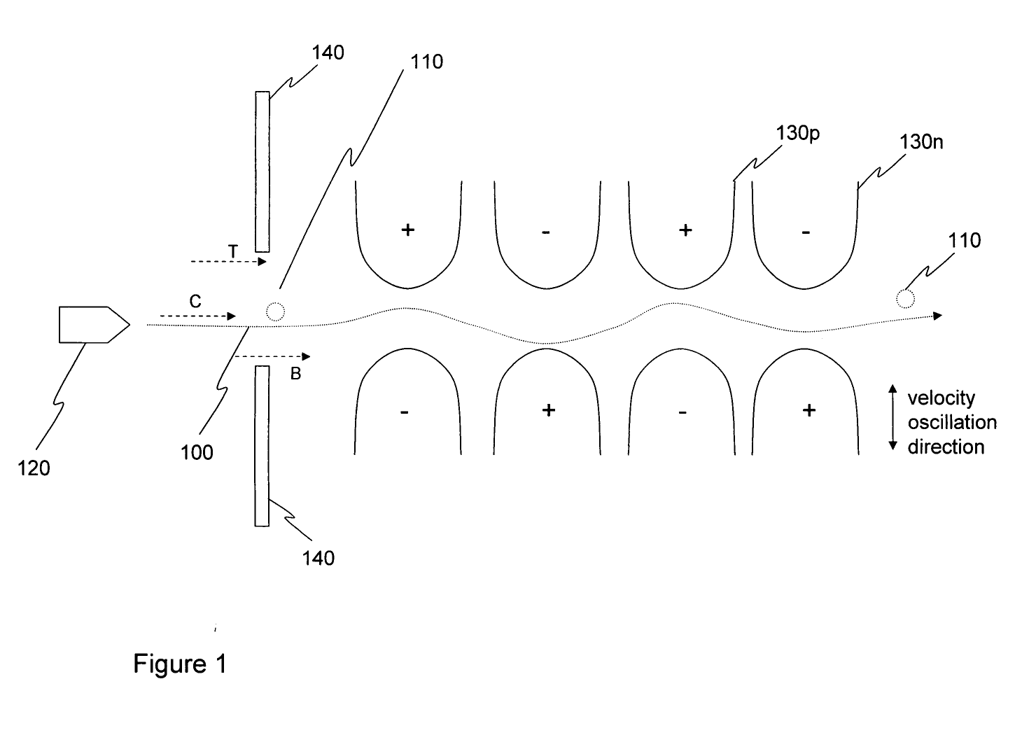

Turning now to the drawings, FIG. 1 is a high-level conceptual representation of a charged particle moving through a series of alternating electric fields according to a first embodiment of the present invention. As shown therein, a charged particle beam 100 including charged particles 110 (e.g., electrons) is generated from a charged particle source 120. The charged particle beam 100 can include ions (positive or negative), electrons, protons and the like. The beam may be produced by any source, including, e.g., without limitation an ion gun, a thermionic filament, a tungsten filament, a cathode, a planar vacuum triode, an electron-impact ionizer, a laser ionizer, a chemical ionizer, a thermal ionizer, an ion-impact ionizer.

As the beam 100 is projected, it passes between plural alternating electric fields 130p and 130n. As used herein, the phrase “positive electric field” 130p should be understood to mean an electric field with a more positive portion on the upper portion of the figure, and the phrase “negative electric field” 130n should be understood to mean an electric field with a more negative portion on the upper portion of the figure. In this first embodiment, the electric fields 130p and 130n alternate not only on the same side but across from each other as well. That is, each positive electric field 130p is surrounded by a negative electric field 130n on three sides. Likewise, each negative electric field 130n is surrounded by a positive field 130p on three sides. In the illustrated embodiment, the charged particles 110 are electrons which are attracted to the positive electric fields 130p and repelled by the negative electric fields 130n. The attraction of the charged particles 110 to their oppositely charged fields 130p or 130n accelerates the charged particles 110 transversely to their axial velocity.

The series of alternating fields creates an oscillating path in the directions of top to bottom of FIG. 1 and as indicated by the legend “velocity oscillation direction.” In such a case, the velocity oscillation direction is generally perpendicular to the direction of motion of the beam 100.

The charged particle source 120 may also optionally include one or more electrically biased electrodes 140 (e.g., (a) grounding electrodes or (b) positively biased electrodes) which help to keep the charged particles (e.g., (a) electrons or negatively charged ions or (b) positively charged ions) on the desired path.

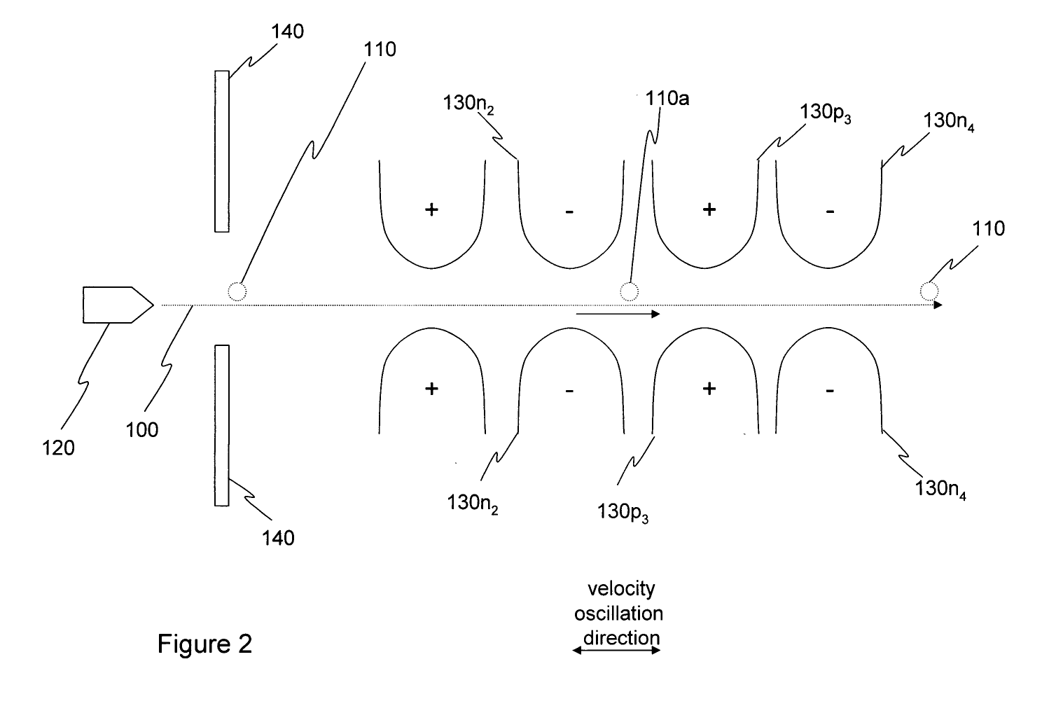

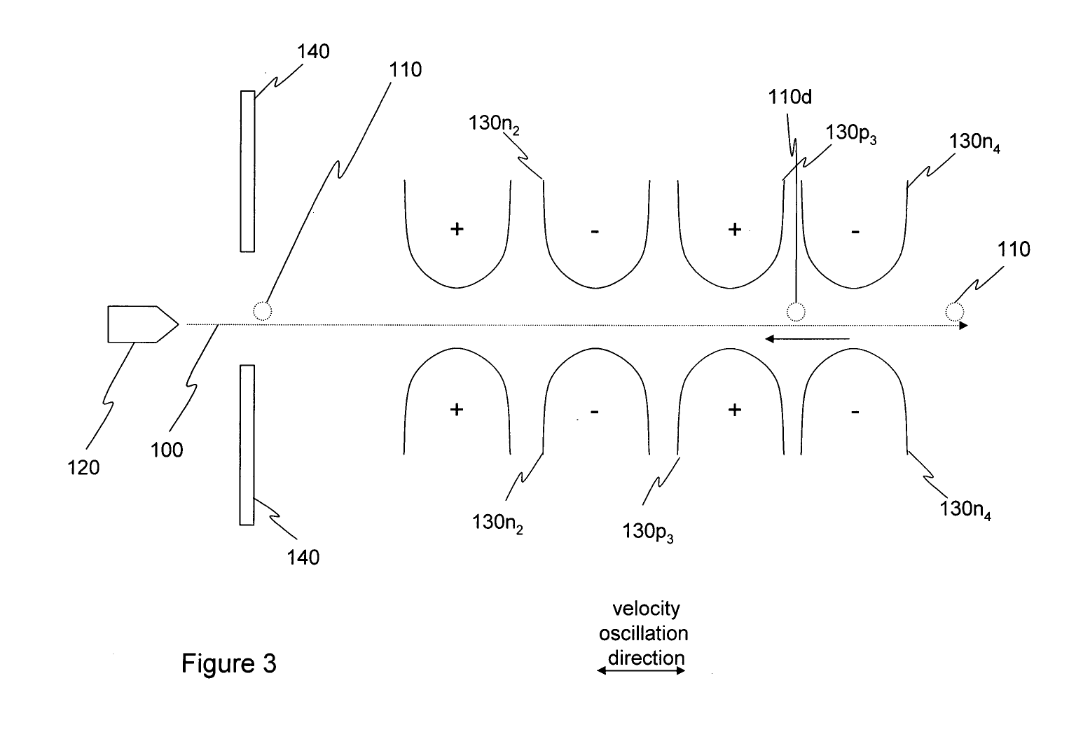

In the alternate embodiments illustrated in FIGS. 2 and 3, various elements from FIG. 1 have been repeated, and their reference numerals are repeated in FIGS. 2 and 3. However, the order of the electric fields 130p and 130n below the path of the charged particle beam 100 has been changed. In FIGS. 2 and 3, while the electric fields 130n and 130p are still alternating on the same side, they are now of opposing direction on opposite sides of the beam 100, allowing for no net force on the charged particles 110 perpendicular to the beam 100. There is, though, a force of oscillatory character acting on the charged particles 100 in the direction of the beam 100. Thus, in the case of an electron acting as a charged particle 110, the electron 110a in FIG. 2 is an accelerating electron that is being accelerated by being repelled from the negative fields 130n₂ while being attracted to the next positive fields 130p₃ in the direction of motion of the beam 100. (The direction of acceleration is shown below the accelerating electron 110a.)

Conversely, as shown in FIG. 3, in the case of an electron acting as a charged particle 110, the electron 110d in FIG. 2 is a decelerating electron that is being decelerated (i.e., negatively accelerated) as it approaches the negative fields 130n₄ while still being attracted to the previous positive fields 130p₃. The direction of acceleration is shown below the decelerating electron 100d. Moreover, both FIGS. 2 and 3 include the legend “velocity oscillation direction” showing the direction of the velocity changes. In such cases, the velocity oscillation direction is generally parallel to the direction of motion of the beam 100. It should be understood, however, that the direction of the electron does not change, only that its velocity increases and decreases in the illustrated direction.

By varying the order and strength of the electric fields 130n and 130p, a variety of magnitudes of acceleration can be achieved allowing for attenuation of the motion of the charged particles 110. As should be understood from the disclosure, the strengths of adjacent electric fields, fields on the same side of the beam 100 and fields on opposite sides of the beam 100 need not be the same strength. Moreover, the strengths of the fields and the directions of the fields need not be fixed either but may instead vary with time. The fields 130n and 130p may even be created by applying a electromagnetic wave to a resonant structure, described in greater detail below.

The electric fields utilized by the present invention can be created by any known method which allows sufficiently fine-tuned control over the paths of the charged particles so that they stay within intended path boundaries.

According to one aspect of the present invention, the electric fields can be generated using at least one resonant structure where the resonant structure resonates at a frequency above a microwave frequency. Resonant structures include resonant structures shown in or constructed by the teachings of the above-identified co-pending applications. In particular, the structures and methods of U.S. application Ser. No. 11/243,477 [Atty. Docket 2549-0059], entitled “Electron Beam Induced Resonance,” filed on Oct. 5, 2005, can be utilized to create electric fields 130 for use in the present invention.

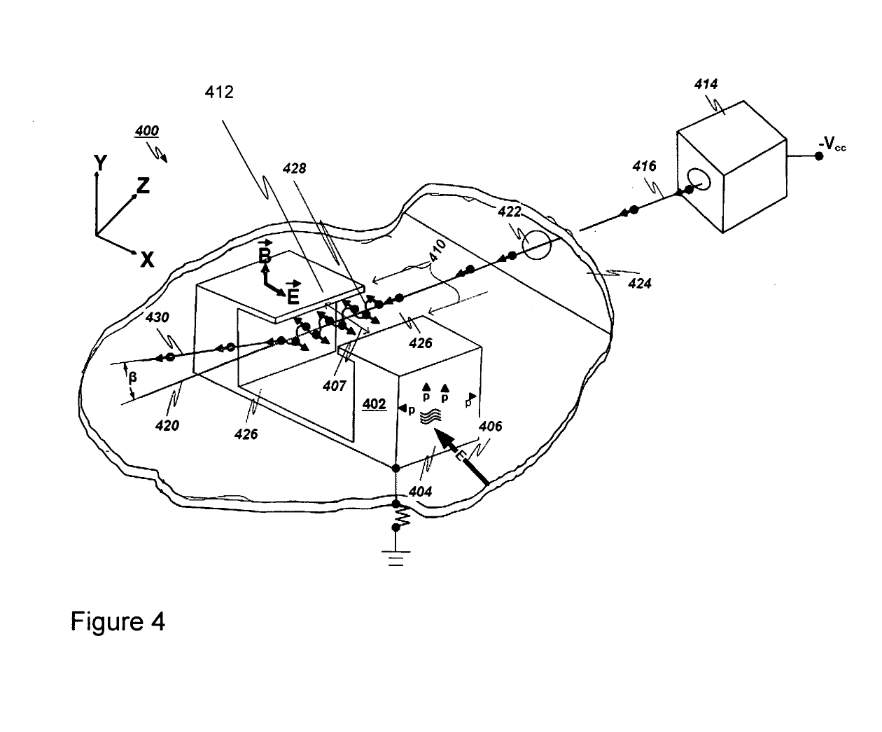

FIG. 4 is a perspective-view, high-level conceptual representation of a charged particle moving through a series of alternating electric fields produced by a resonant structure (RS) 402 (e.g., a microwave resonant structure or an optical resonant structure). An electromagnetic wave 406 (also denoted E) incident to a surface 404 of the RS 402 transfers energy to the RS 402, which generates a varying field 407. In the exemplary embodiment shown in FIG. 4, a gap 410 formed by ledge portions 412 can act as an intensifier. The varying field 407 is shown across the gap 410 with the electric and magnetic field components (denoted \vec{E} and \vec{B}) generally along the X and Y axes of the coordinate system, respectively. Since a portion of the varying field can be intensified across the gap 410, the ledge portions 412 can be sized during fabrication to provide a particular magnitude or wavelength of the varying field 407.

A charged particle source 414 (such as the source 120 described with reference to FIGS. 1-3) targets a beam 416 (such as a beam 100) of charged particles (e.g., electrons) along a straight path 420 through an opening 422 on a sidewall 424 of the device 400. The charged particles travel through a space 426 within the gap 410. Upon interaction with the varying field 426, the charged particles are shown angularly modulated from the straight path 420. Generally, the charged particles travel on an oscillating path 428 within the gap 410. After passing through the gap 410, the charged particles are angularly modulated on a new path 430. An angle β illustrates the deviation between the new path 430 and the straight path 420.

As would be appreciated by one of ordinary skill in the art, a number of resonant structures 402 can be repeated to provide additional electric fields for influencing the charged particles of the beam 416. Alternatively, the direction of the oscillation can be changed by turning the resonant structure 402 on its side onto surface 404.

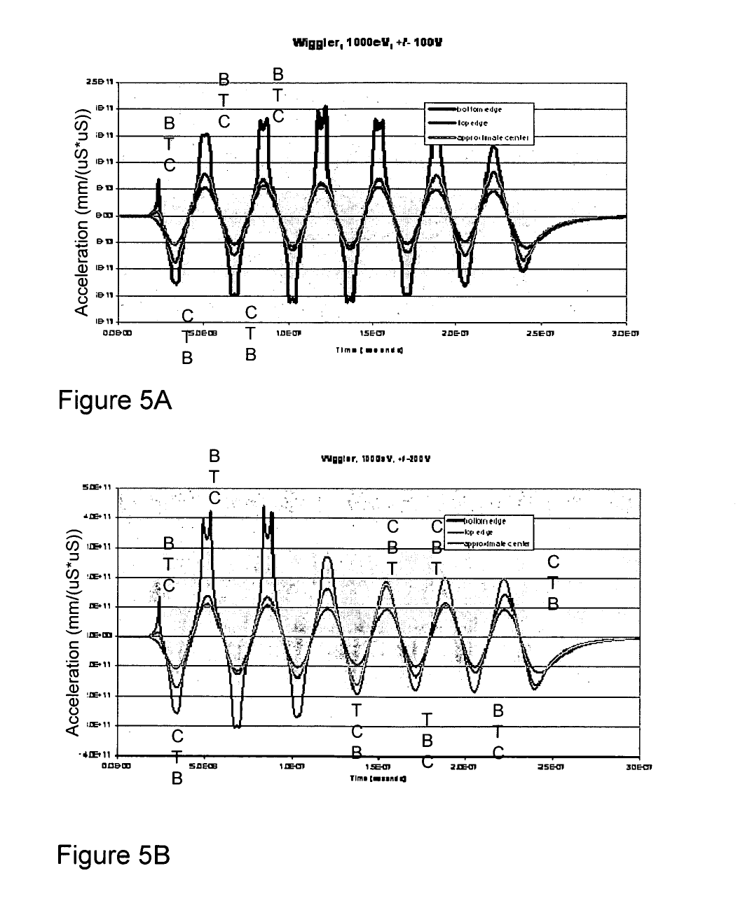

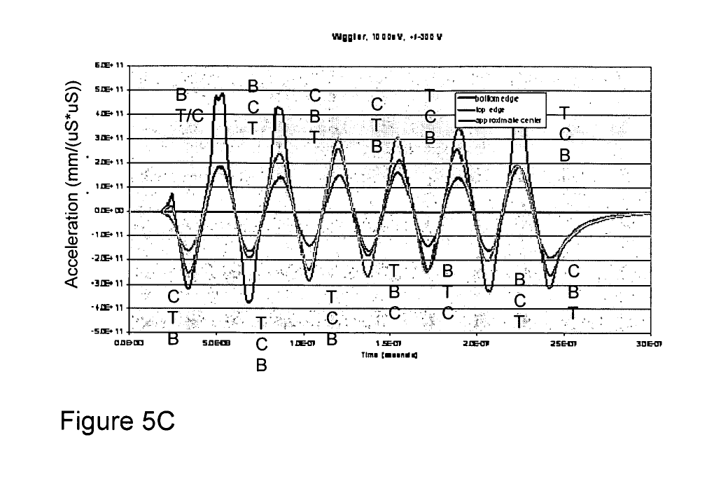

FIGS. 5A-5C are outputs of computer simulations showing trajectories and accelerations of model devices according to the present invention. The outputs illustrate three exemplary paths, labeled “B”, “T” and “C” for bottom, top and center, respectively. As shown on FIG. 1, these correspond to charged particles passing through the bottom, top and center, respectively, of the opening between the electrodes 140. Since the curves for B, T and C cross in various locations, the graphs are labeled in various locations. As can be seen in FIG. 5A, the calculations show accelerations of about 0.5×10¹¹ mm/μS² for electrons with 1 keV of energy passing through a potential of +/−100 volts when passing through the center of the electrodes. FIG. 5B shows accelerations of about 1.0×10¹¹ mm/μS² for electrons with 1 keV of energy passing through a potential of +/−200 volts when passing through the center of the electrodes. FIG. 5C shows accelerations of about 1.0-3.0×10¹¹ mm/μS² for electrons with 1 keV of energy passing through a potential of +/−300 volts when passing through the center of the electrodes.

Utilizing the alternating electric fields of the present invention, the oscillating charged particles emit photons to achieve a radiation emitting device. Such photons can be used to provide radiation outside the device or to provide radiation for use internally as well. Moreover, the amount of radiation emitted can be used as part of a measurement device. It is also possible to construct the electrode of such a size and spacing that they resonate at or near the frequency that is being generated. This effect can be used to enhance the applied fields in the frequency range that the device emits.

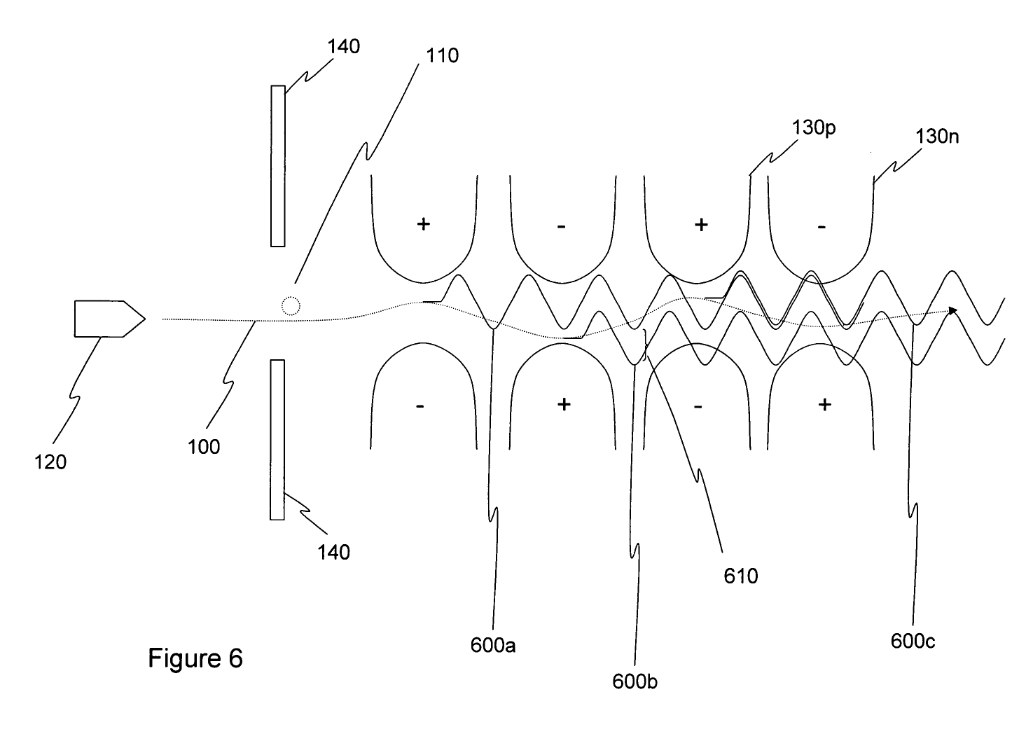

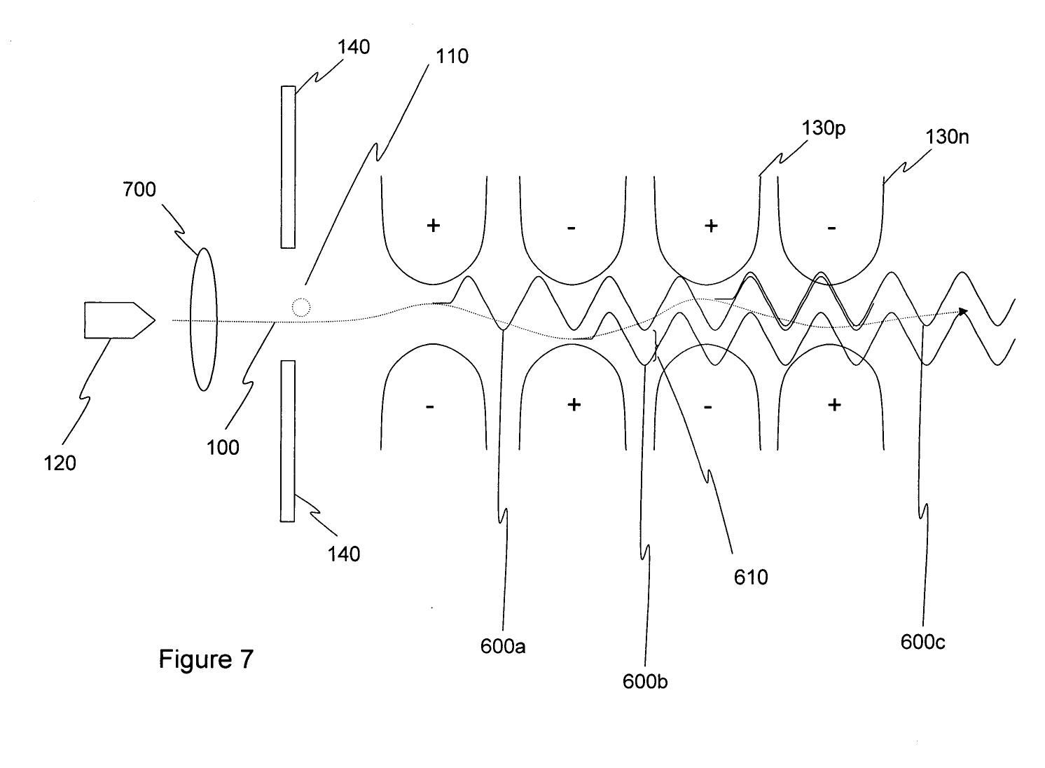

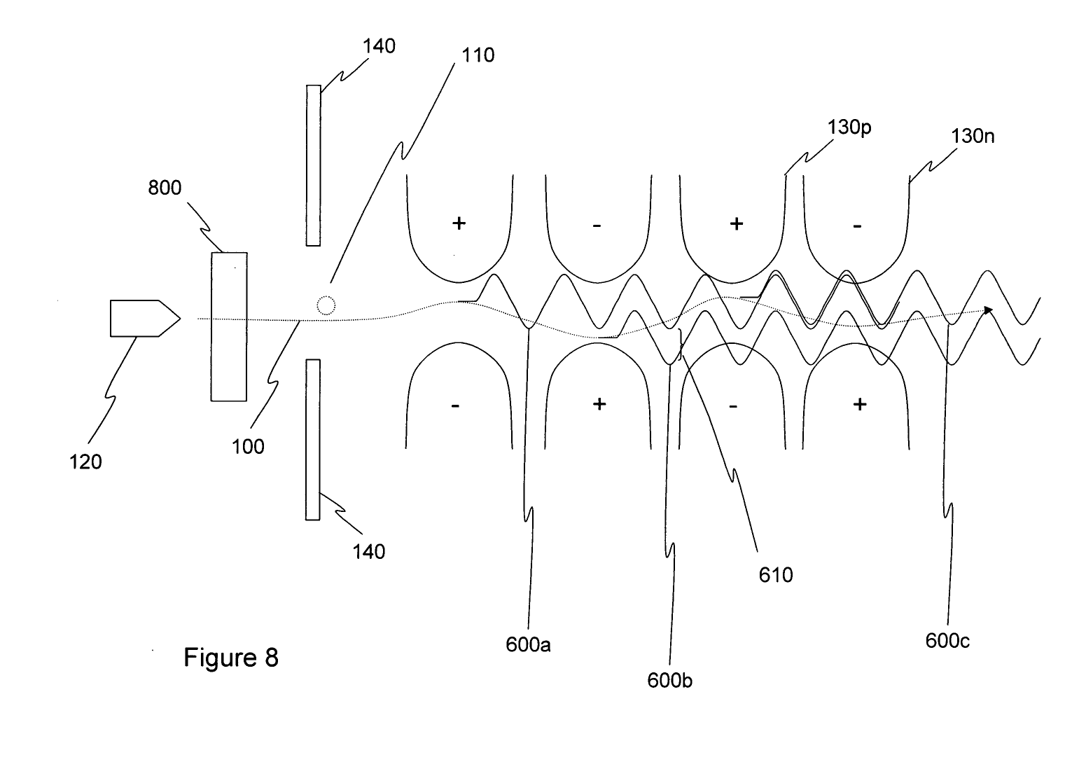

Turning to FIG. 6, the structure of FIG. 1 has been supplemented with the addition of photons 600a-600c. In the illustrated embodiment, the electric fields 130p and 130n are selected such that the charged particles 110 are forced into an oscillating trajectory at (or nearly at) an integral multiple of the emitted wavelength. Using such a controlled oscillation, the electromagnetic radiation emitted at the maxima and minima of the oscillation constructively interferes with the emission at the next minimum or maximum. As can be seen, for example at 610, the photon emissions are in phase with each other. This produces a coherent radiation source that can be used in laser applications such as communications systems using optical switching.

In light of the variation in paths that a charged particle can undergo based on its initial path between electrodes 140, in a second embodiment of a coherent radiation source, a focusing element 700 is added in close proximity to the electrodes 140. The focusing element 700, while illustrated as being placed before the electrodes 140 may instead be placed after. In such a configuration, additional charged particles may traverse a center path between the fields and undergo constructive interference.

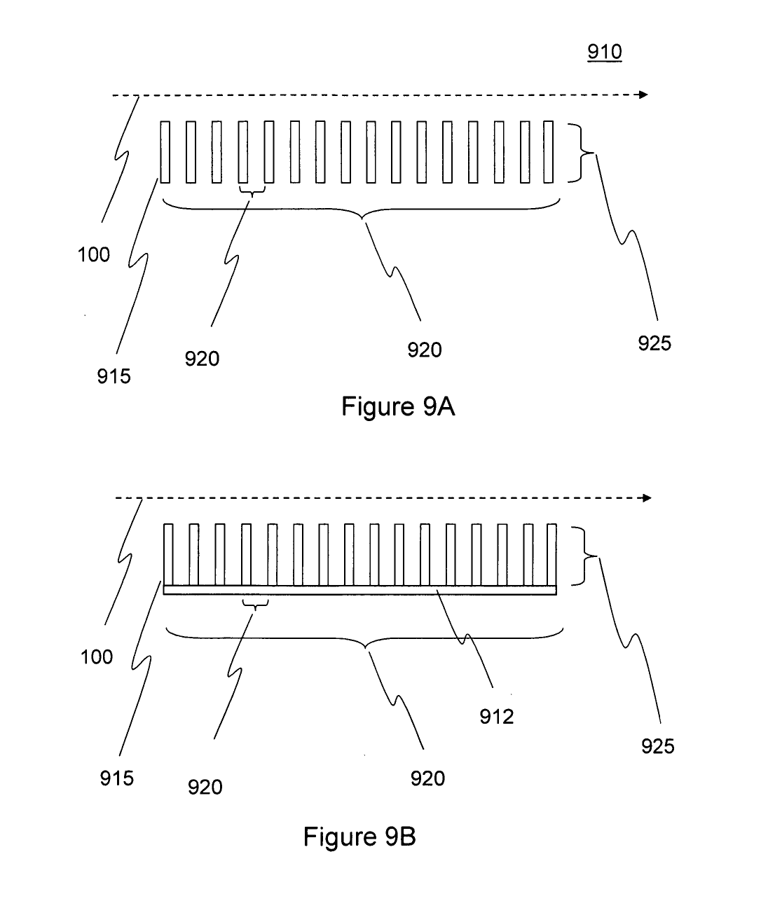

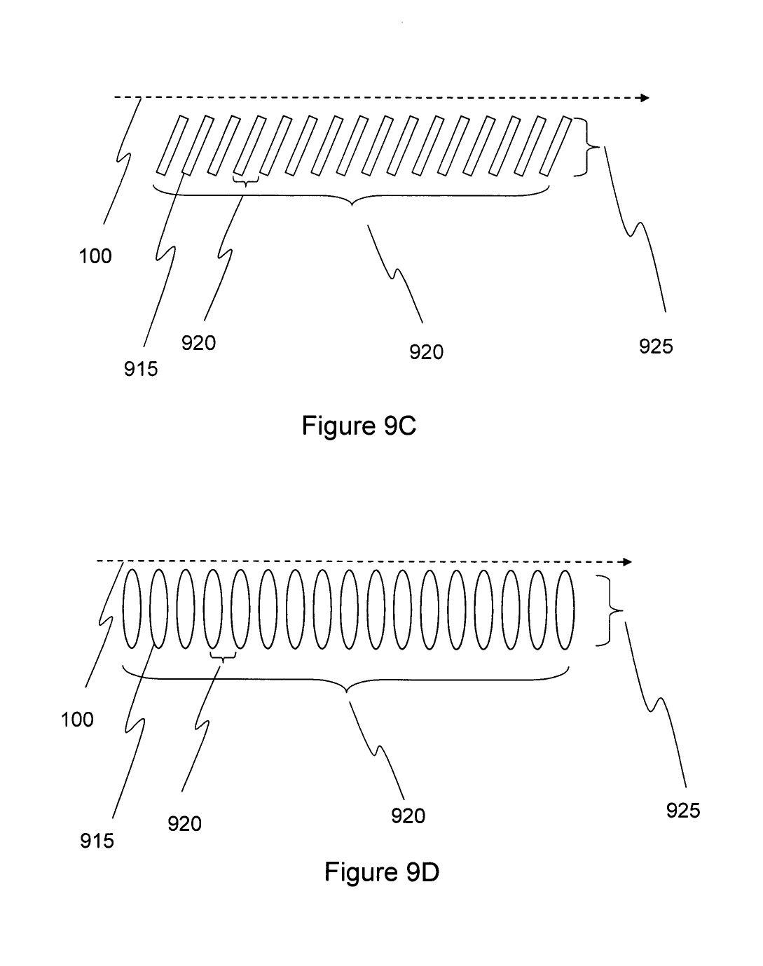

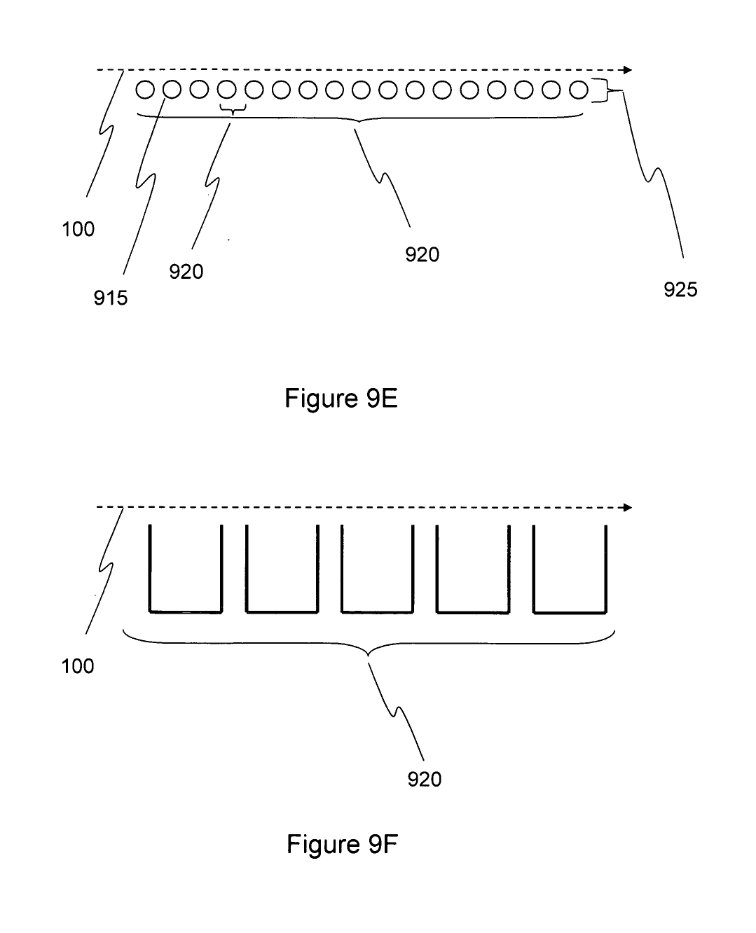

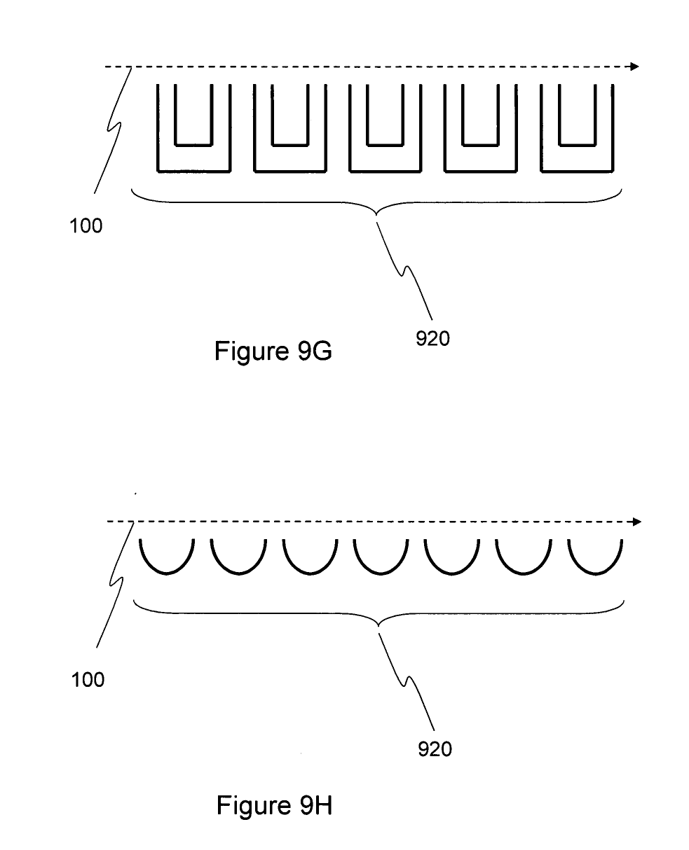

In a third embodiment of a coherent light source, a pre-bunching element 800 is added which helps to control the inter-arrival time between charged particles, and therefore aid in the production of coherent Electromagnetic Radiation (EMR). One possible configuration of a pre-bunching element 800 is a resonant structure such as is described in U.S. application Ser. No. 11/410,924, [Attorney Docket No. 2549-0010] entitled “Selectable Frequency EMR Emitter,” filed on Apr. 26, 2006 and incorporated herein by reference. However, exemplary resonant structures are shown in FIGS. 9A-9H. As shown in FIG. 9A, a resonant structure 910 may comprise a series of fingers 915 which are separated by a spacing 920 measured as the beginning of one finger 915 to the beginning of an adjacent finger 915. The finger 915 has a thickness that takes up a portion of the spacing between fingers 915. The fingers also have a length 925 and a height (not shown). As illustrated, the fingers 915 of FIG. 9A are perpendicular to the beam 100.

Resonant structures 910 are fabricated from resonating material [e.g., from a conductor such as metal (e.g., silver, gold, aluminum and platinum or from an alloy) or from any other material that resonates in the presence of a charged particle beam]. Other exemplary resonating materials include carbon nanotubes and high temperature superconductors.

Any of the various resonant structures can be constructed in multiple layers of resonating materials but are preferably constructed in a single layer of resonating material (as described above). In one single layer embodiment, all of the parts of a resonant structure 910 are etched or otherwise shaped in the same processing step. In one multi-layer embodiment, resonant structures 910 of the same resonant frequency are etched or otherwise shaped in the same processing step. In yet another multi-layer embodiment, all resonant structures having segments of the same height are etched or otherwise shaped in the same processing step. In yet another embodiment, all of the resonant structures on a single substrate are etched or otherwise shaped in the same processing step.

The material need not even be a contiguous layer, but can be sub-parts of the resonant structures individually present on a substrate. The materials making up the sub-parts of the resonant structures can be produced by a variety of methods, such as by pulsed-plating, depositing, sputtering or etching. Preferred methods for doing so are described in co-pending U.S. application Ser. No. 10/917,571, filed on Aug. 13, 2004, entitled “Patterning Thin Metal Film by Dry Reactive Ion Etching,” and in U.S. application Ser. No. 11/203,407, filed on Aug. 15, 2005, entitled “Method Of Patterning Ultra-Small Structures,” both of which are commonly owned at the time of filing, and the entire contents of each of which are incorporated herein by reference.

At least in the case of silver, etching does not need to remove the material between segments or posts all the way down to the substrate level, nor does the plating have to place the posts directly on the bare substrate. Silver posts can be on a silver layer on top of the substrate. In fact, we discovered that due to various coupling effects, better results are obtained when the silver posts are set on a silver layer that is deposited on the substrate.

As shown in FIG. 9B, the fingers of the resonant structure 910 can be supplemented with a backbone. The backbone 912 connects the various fingers 915 of the resonant structure 910 forming a comb-like shape. Typically, the backbone 912 would be made of the same material as the rest of the resonant structure 910, but alternative materials may be used. In addition, the backbone 912 may be formed in the same layer or a different layer than the fingers 915. The backbone 912 may also be formed in the same processing step or in a different processing step than the fingers 915. While the remaining figures do not show the use of a backbone 912, it should be appreciated that all other resonant structures described herein can be fabricated with a backbone also.

The shape of the fingers 915 (or posts) may also be shapes other than rectangles, such as simple shapes (e.g., circles, ovals, arcs and squares), complex shapes [e.g., semi-circles, angled fingers, serpentine structures and embedded structures (i.e., structures with a smaller geometry within a larger geometry, thereby creating more complex resonances)] and those including waveguides or complex cavities. The finger structures of all the various shapes will be collectively referred to herein as “segments.” Other exemplary shapes are shown in FIGS. 9C-9H, again with respect to a path of a beam 100. As can be seen at least from FIG. 9C, the axis of symmetry of the segments need not be perpendicular to the path of the beam 100.

Exemplary dimensions for resonant structures include, but are not limited to:
(a) period (920) of segments: 150-220 nm;
(b) segment thickness: 75-110 nm;
(c) height of segments: 250-400 nm;
(d) length (925) of segments: 60-180 nm; and
(e) number of segments in a row: 200-300.

While the above description has been made in terms of structures for achieving the acceleration of charged particles, the present invention also encompasses methods of accelerating charged particles generally. Such a method includes: generating a beam of charged particles; providing a series of alternating electric fields along an intended path; and transmitting the beam of charged particles along the intended path through the alternating electric fields.

The resonant structures producing coherent light described above can be laid out in rows, columns, arrays or other configurations such that the intensity of the resulting EMR is increased.

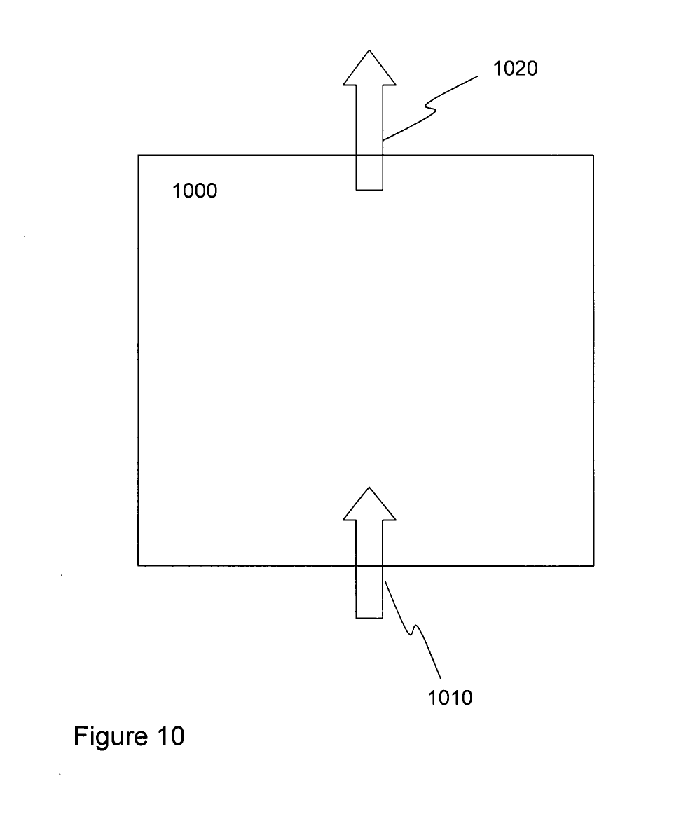

The coherent EMR produced may additionally be used as an input to additional devices. For example, the EMR may be used as an input to a light amplifier such as a Raman laser. As shown in FIG. 10, a Raman laser 1000 receives substantially coherent light at an input 1010 and outputs a laser signal at an output 1020. The Raman laser may be made from any Raman medium and is preferably made of a medium that integrates with the fabrication of the EMR source.

By integrating the coherent EMR sources described above with Raman laser elements that can be similarly integrated into a semiconductor process, the combined switching devices can enjoy a high degree of integration. However, the Raman laser elements may be fabricated in a different integrated circuit than the source of the coherent EMR. The optical switching element may form part of a micro-electro-mechanical systems (MEMS), or may be part of a multi-chip module which is combined with a coherent EMR.

In addition to using coherent EMR from the above structures using a pre-bunching element and alternating electric fields, it is also possible to utilize substantially coherent EMR produced directly from a resonant structure which is caused to resonate by passing a beam of charged particles in close enough proximity to a resonant structure that the resonant structure itself emits EMR. The frequency of the EMR can be controlled by properly selecting the dimensions of the resonant structure, such as is described in U.S. application Ser. No. 11/410,924, [Attorney Docket No. 2549-0010] entitled “Selectable Frequency EMR Emitter,” filed on Apr. 26, 2006.

When using the resonant structures or the series of alternating fields, electromagnetic radiation at frequencies other than a desired frequency may be produced. Accordingly, one or more filters may be placed between the source of the substantially coherent light (e.g., either the resonant structures or the series of alternating fields) and the input to the Raman laser. This removes the unwanted frequencies so that the filtered light can better excite the Raman laser.

The resulting Raman laser can then be used in any existing environment that Raman lasers have been used in previously. Exemplary uses include telecommunications systems using laser-based signals carried over fiber-optic cables.

As would be understood by one of ordinary skill in the art, the above exemplary embodiments are meant as examples only and not as limiting disclosures. Accordingly, there may be alternate embodiments other than those described above which nonetheless still fall within the scope of the pending claims.

1. A laser system comprising:
a source of charged particles;
a resonant structure configured to be excited by particles emitted from the source of charged particles and configured to emit electromagnetic radiation at a predominant frequency representing the data to be transmitted, wherein the predominant frequency has a frequency higher than that of a microwave frequency; and
a Raman laser including an input for receiving the predominant frequency from the resonant structure.

2. The laser system as claimed in claim 1, wherein the resonant structure and the Raman laser are formed in a single integrated circuit.

3. The laser system as claimed in claim 1, wherein the resonant structure and the Raman laser are formed in different integrated circuits.

4. A laser system comprising:
a series of alternating electric fields along an intended path;
a pre-bunching element;
a source of charged particles configured to transmit charged particles along an oscillating trajectory through the pre-bunching element and through the series of alternating electric fields, wherein the oscillating trajectory has a wavelength close to that of radiation emitted from the charged particles during oscillation and wherein the radiation emitted from the charged particles undergoes constructive interference and produces coherent light;
a Raman laser including an input for receiving the coherent light.

5. The laser system as claimed in claim 4, wherein the pre-bunching element and the Raman laser are formed in a single integrated circuit.

6. The laser system as claimed in claim 4, wherein the pre-bunching element and the Raman laser are formed in different integrated circuits.

7. The laser system as claimed in claim 4, wherein the pre-bunching element comprises a resonant structure.
